(19) United States
(12) Patent Application Publication
(10) Pub. No.: US 2026/0017687 A1
(43) Pub. Date: Jan. 15, 2026

(54) REWARDS LEDGER FOR REGULATORY-COMPLIANT REWARDS TRACKING

(71) Applicant: Quanata, LLC, San Francisco, CA (US)

(72) Inventors: Christopher John Deptula, Playa Vista, CA (US); Michael Joseph Koslap, Yardley, PA (US)

(73) Assignee: Quanata, LLC, San Francisco, CA (US)

(21) Appl. No.: 18/770,025

(22) Filed: Jul. 11, 2024

(51) Int. Cl. G06Q 30/0226; G06Q 10/0635; G06Q 50/26

(52) U.S. Cl. CPC G06Q 30/0233; G06Q 10/0635; G06Q 50/26

(57) ABSTRACT

A method including obtaining reward information for a reward for a user, the reward information comprising a reward category, a credit type, and a reward value. The method also can include identifying one or more regulatory frameworks applying to the user and determining a respective limit for each of the one or more regulatory frameworks. Additionally, the method can include determining a respective amount available within the respective limit for the user for each of the one or more regulatory frameworks. Furthermore, the method can include determining whether the reward value exceeds the respective amount available for any of the one or more regulatory frameworks and, when the reward value exceeds the respective amount available for any of the one or more regulatory frameworks, preventing redemption of the reward. Other embodiments are disclosed.

### FIELD OF THE DISCLOSURE

The present disclosure generally relates to technologies for regulatory-compliant rewards tracking.

### BACKGROUND

Many companies provide rewards to users to incentivize certain behaviors. For example, rewards can foster customer research, loyalty, and retention, can incentivize learning and other desirable behaviors, can promote business development, etc. These incentives can be of different types, such as monetary rewards, which might include cashback or account credits, discounts on premiums or services, and digital rewards, such as badges or points, which can be part of a gamification strategy. The issuance of rewards, particularly those with monetary value, can be subject to various state and federal regulations.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a front elevation view of a computer system that is suitable for implementing an exemplary embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system for managing rewards, according to certain embodiments;

FIG. 4 illustrates a block diagram of exemplary components of the reward system of the system of FIG. 3;

FIG. 5 illustrates a block diagram of exemplary components of reward service of the reward system of FIG. 4;

FIG. 6 illustrates an entity relationship diagram of an exemplary data model that can be used for the data stored in the reward database of the reward system of FIG. 4, according to certain embodiments;

FIG. 7 illustrates a sequence diagram for a method for retrieving a reward recipient, according to certain embodiments;

FIG. 8 illustrates a sequence diagram for a method of redeeming a reward, according to certain embodiments;

FIG. 9 illustrates a sequence diagram for a method of processing a customer care statement credit, according to certain embodiments;

FIG. 10 illustrates a sequence diagram for a method of processing a reward based on customer engagement, according to certain embodiments; and

FIG. 11 illustrates a flowchart of a method for managing rewards in regulatory-compliant rewards tracking, according to certain embodiments.

The figures depict preferred embodiments for purposes of illustration only. One skilled in the art will readily recognize from the following discussion that alternative embodiments of the systems and methods illustrated herein can be employed without departing from the principles of the invention described herein.

### DETAILED DESCRIPTION OF EXAMPLES OF EMBODIMENTS

The present embodiments can generally relate to managing the issuance of rewards for a company or other entity. This system is capable of capturing, tracking, and automatically limiting the total annual dollar amount of rewards or other set limitations that can be awarded to a customer. The system can ensure compliance with various state, city, local, and federal regulations that govern the issuance of such rewards. In some embodiments, the system can be used to track various types of rewards, including but not limited to digital rewards such as badges. The system can be used to track rewards of monetary value, categorizing them based on their source, such as challenges, customer care, marketing, or customer research.

In some embodiments, the system can provide that rewards of monetary value are not issued, or other limitations, such as the number of rewards in a certain time period, beyond federal, city, local, and/or state limits that would trigger tax events or other regulatory considerations. These limitations can be achieved by categorizing rewards based on whether they are considered instruments for mitigating risk, which can be exempt from various state-level regulatory limits, or whether they are issued as promotional or for research, which may not be exempt from such regulatory limits.

In some embodiments, the system can provide a central ledger that can be written to and read from each time a customer earns a reward. This ledger can provide a single source for tracking these limits, allowing companies to confidently offer and issue rewards without fear of triggering or exceeding regulatory limits.

In some embodiments, the system can be used by any company that has a rewards benefit for customers, providing a valuable tool for managing the issuance of rewards in compliance with regulatory limits. For example, in the field of auto insurance, customer retention is a significant effort for insurance providers. Various strategies are employed to keep customers engaged and loyal to the insurance provider. One such strategy is the use of rewards. These rewards can take various forms, including monetary rewards, discounts, and digital rewards such as badges. The rewards can be issued for various reasons, such as for completing challenges, for customer care, for marketing purposes, or for customer research. However, the issuance of rewards, particularly those with monetary value, is subject to various local, city, state, and federal regulations. These regulations often set limits on the total annual dollar amount that can be awarded to a customer. The limits can vary depending on the category of the reward, such as whether the reward is considered a risk mitigation measure or a promotional item. Furthermore, the limits can vary from state to state, adding another layer of complexity to the tracking and issuance of rewards.

In conventional systems, there is no single source for tracking all of these limits and the rewards issued to each customer. This lack of a centralized tracking system limits the confidence of insurance providers in issuing rewards, for fear of inadvertently exceeding regulatory limits. These concerns can result in missed opportunities for customer engagement and retention. Moreover, the process of tracking rewards and ensuring compliance with regulatory limits is often manual and time-consuming, which can lead to errors and inefficiencies, further limiting the effectiveness of rewards as a customer retention strategy.

In many embodiments, the techniques described herein can provide a system that can accurately track various rewards, categorize them according to regulatory requirements, and automatically limit a maximum and/or minimum total annual dollar amount that can be awarded to a customer, while ensuring compliance with state, city, local, and federal regulations. Such a system can enhance the ability of insurance providers to confidently issue rewards and engage their customers.

Various embodiments include a computer-implemented method. The method can include obtaining reward information for a reward for a user, the reward information comprising a reward category, a credit type, and a reward value. The method also can include identifying one or more regulatory frameworks applying to the user and determining a respective limit for each of the one or more regulatory frameworks. Additionally, the method can include determining a respective amount available within the respective limit for the user for each of the one or more regulatory frameworks. Furthermore, the method can include determining whether the reward value exceeds the respective amount available for any of the one or more regulatory frameworks and, when the reward value exceeds the respective amount available for any of the one or more regulatory frameworks, preventing redemption of the reward.

A number of embodiments include a system comprising one or more processors and one or more non-transitory computer-readable media storing computing instructions that, when executed on the one or more processors, cause the one or more processors to perform various operations. The operations can include obtaining reward information for a reward for a user, the reward information comprising a reward category, a credit type, and a reward value. The operations also can include identifying one or more regulatory frameworks applying to the user and determining a respective limit for each of the one or more regulatory frameworks. Additionally, the operations can include determining a respective amount available within the respective limit for the user for each of the one or more regulatory frameworks. Furthermore, the operations can include determining whether the reward value exceeds the respective amount available for any of the one or more regulatory frameworks and, when the reward value exceeds the respective amount available for any of the one or more regulatory frameworks, preventing redemption of the reward.

Some embodiments include one or more non-transitory computer-readable media storing computing instructions that, when executed on one or more processors, cause the one or more processors to perform various operations. The operations can include obtaining reward information for a reward for a user, the reward information comprising a reward category, a credit type, and a reward value. The operations also can include identifying one or more regulatory frameworks applying to the user and determining a respective limit for each of the one or more regulatory frameworks. Additionally, the operations can include determining a respective amount available within the respective limit for the user for each of the one or more regulatory frameworks. Furthermore, the operations can include determining whether the reward value exceeds the respective amount available for any of the one or more regulatory frameworks and, when the reward value exceeds the respective amount available for any of the one or more regulatory frameworks, preventing redemption of the reward.

Advantages will become more apparent to those skilled in the art from the following description of the preferred embodiments which have been shown and described by way of illustration. As will be realized, the present embodiments can be capable of other and different embodiments, and their details are capable of modification in various respects. Accordingly, the drawings and description are to be regarded as illustrative in nature and not as restrictive.

In many embodiments, the systems described herein can provide a practical application and several technological improvements to the management of rewards. The system can offer a technical improvement to existing methods of tracking and issuing rewards by automating compliance with state, city, local, and federal regulations. In particular, the system can categorize rewards and automatically limit the total annual dollar amount that can be awarded to a customer, thereby preventing the issuance of rewards that could trigger tax events or violate regulatory considerations. This represents a substantial improvement over conventional systems that may rely on manual tracking and lack the capability to ensure compliance with such precision.

In some aspects, the system can include a central ledger that captures and records every instance a customer earns a reward. This ledger can be a single source for tracking all regulatory limits associated with rewards, which can be categorized by their source, such as challenges, customer care, marketing, or customer research. Moreover, the system can prevent the redemption of rewards that exceed the regulatory limits, thereby providing a real-time compliance check and enhancing the confidence of insurance providers in their rewards programs. Additionally, the system can provide a technological advancement over traditional rewards management systems that do not have the capability to track and limit rewards across various regulatory frameworks, nor the ability to provide real-time updates to both the insurer and the customer regarding the status of earned and available rewards.

### Exemplary Computer Systems

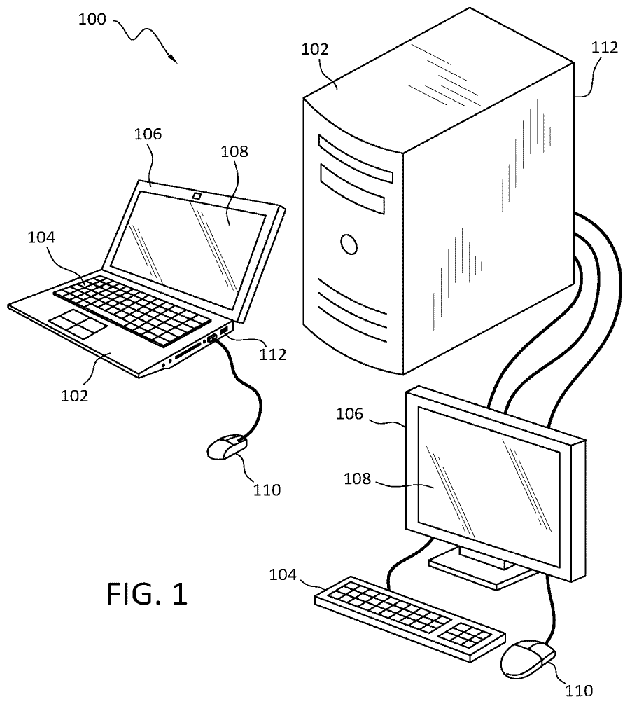

Turning to the drawings, FIG. 1 illustrates an exemplary embodiment of two different types (e.g., a laptop and a tower server) a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all of, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia Interface (HDMI) ports, etc.).

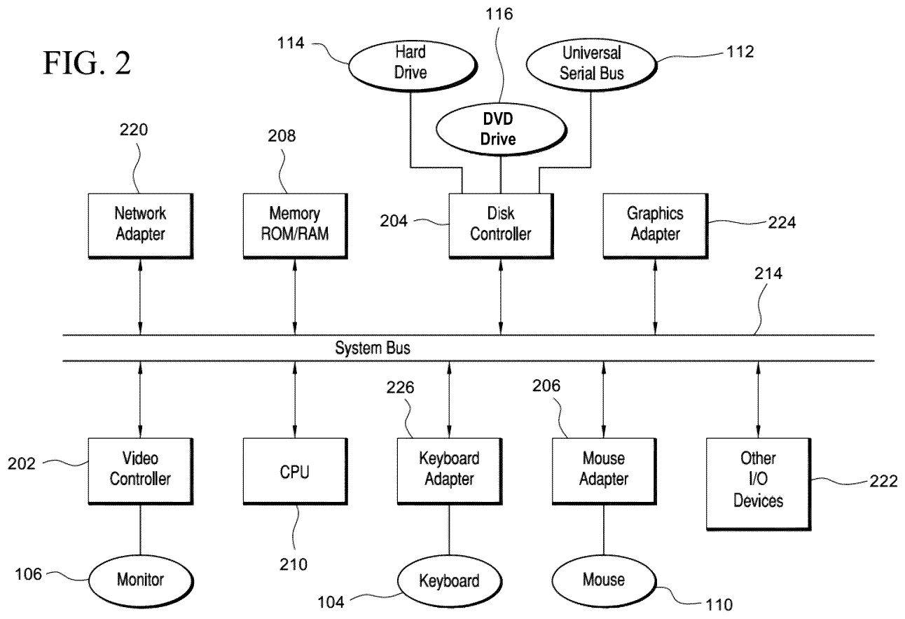

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 can be compliant with any of a variety of commercially distributed architecture families.

Continuing with FIG. 2, system bus 214 can also be coupled to memory storage unit 208 that includes both read only memory (ROM) and random-access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in CD-ROM and/or DVD drive 116 (FIG. 2) inside chassis 102 (FIG. 1) or in a detachable drive coupled to input/output port 112 (FIGS. 1-2).

Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS.

Further exemplary operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, an application specific integrated circuit (ASIC), a field programmable gate array (FPGA), or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable drive coupled to input/output port 112 (FIGS. 1-2), on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components can reside at various times in different storage components of computer system 100, and can be executed by CPU 210. Alternatively, or in addition to, the systems and procedures described herein can be implemented in hardware, or a combination of hardware, software, and/or firmware. For example, one or more ASICs can be programmed to carry out one or more of the systems and procedures described herein. For example, one or more of the programs and/or executable program components described herein can be implemented in one or more ASICs.

Although computer system 100 is illustrated as a laptop computer or a tower server in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, smart watch, wearable, virtual reality headset, augmented reality glasses, etc. In certain additional embodiments, computer system 100 can comprise an embedded system.

### Exemplary Computer Systems for Rewards Ledger

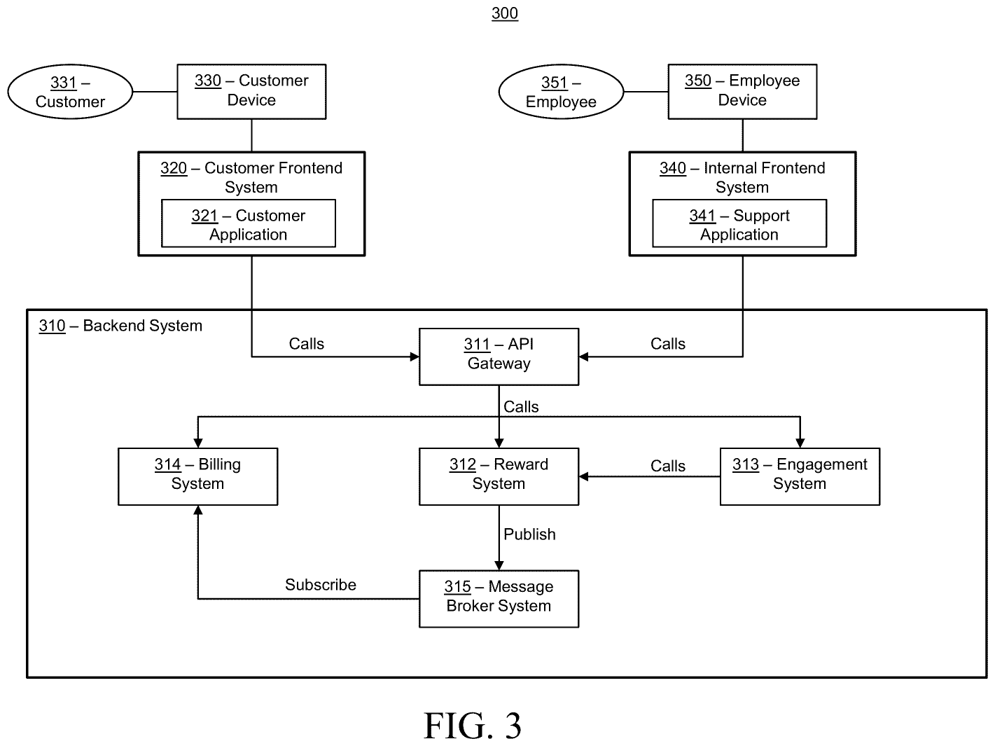

Turning to ahead in the drawings, FIG. 3 illustrates a block diagram of a system 300 for managing rewards. System 300 is exemplary and not limited to the embodiments presented herein. The system can be employed in many different embodiments or examples not specifically depicted or described herein. In some embodiments, various components of system 300 can perform a range of procedures, processes, operations, actions, and/or activities. In other embodiments, these procedures, processes, operations, actions, and/or activities can be performed by other suitable components of system 300.

System 300 can be implemented with hardware and/or software, as described herein. In some embodiments, part or all of the hardware and/or software can be conventional, while in these or other embodiments, part or all of the hardware and/or software can be customized for implementing part or all of the functionality of system 300 described herein.

In some embodiments, system 300 can include a backend system 310, a customer frontend system 320, and/or an internal frontend system 340. Backend system 310 and frontend systems 320 and 340 can each be a computer system, such as computer system 100 (FIG. 1), as described above, and can each be a single computer, a single server, or a cluster or collection of computers or servers, or a cloud of computers or servers. In another embodiment, a single computer system can host each of the backend and frontend systems.

In many embodiments, backend system 310 can be modules of computing instructions stored on non-transitory computer-readable media that operate on one or more processors. In other embodiments, backend system 310 can be implemented in hardware. In many embodiments, backend system 310 can comprise one or more systems, subsystems, modules, models, or servers.

In some embodiments, backend system 310 can be in data communication, through a computer network, a satellite network, a telephone network, or the Internet, with customer frontend system 320, and/or internal frontend system 340. In some embodiments, customer frontend system 320 can be used by customers (e.g., a customer 331) using customer devices (e.g., a customer device 330. For example, customer 331 can be an insurance policyholder who receives rewards. In many embodiments, customer frontend system 320 can host a customer application 321, which can be an application with which the customer interacts. Customer application 321 can be a web application, a mobile application, etc., which can be accessible by customer device 330. For example, customer application 321 can notify customers of rewards that are issued, allow the customer to redeem rewards, show the status and/or history of rewards activity, etc. The customer application 321 can allow customers 331 to interact with the reward system (e.g., 312 described below). For example, customers (e.g., 331) may complete challenges, earn rewards, and redeem rewards through the customer application 321.

In some embodiments, internal frontend system 340 can be used by employees (e.g., an employee 351) using employee devices (e.g., an employee device 350). For example, employee 351 can by an employee of the entity that owns or operates backend system 310, and/or can administer, configure, and/or operate backend system 310 through internal frontend system 340, or provide customer support to customers (e.g., 331) using internal frontend system 340. In some embodiments, internal frontend system 340 can host a support application 341 that the internal support teams use. For example, support application 341 can be used by the employees (e.g., 351) to manage and monitor the reward system (e.g., 312 described below), and/or to assist the customers (e.g., 331), such as providing information about rewards that have been issued and/or redeemed by the customer, the status and/or history of rewards activity, etc. For instance, employees 351 may use the support application 341 to issue rewards, track rewards, and ensure compliance with regulatory limits. In some embodiments, an internal network (not shown) that is not open to the public can be used for communications between backend system 310 and frontend systems 320 and/or 340.

In many embodiments, backend system 310 and/or frontend systems 320 and/or 340 can include one or more input devices, one or more output devices, one or more processors, and/or one or more memory storage devices. Examples of the input devices can include one or more keyboards, one or more keypads, one or more pointing devices such as a computer mouse or computer mice, one or more touchscreen displays, a microphone, keyboard 104 (FIG. 1), mouse 110 (FIG. 1), etc. Examples of the output devices can include one or more monitors, one or more touch screen displays, projectors, monitor 106 (FIG. 1), screen 108 (FIG. 1), etc. Examples of the processors can include CPU 210 (FIG. 2), etc. Examples of the memory storage devices can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc.

The input devices and the output devices can be coupled to backend system 310 and/or frontend systems 320 and/or 340 in a wired or wireless manner, and the coupling can be direct or indirect, as well as locally or remotely. As an example of an indirect manner (which can or cannot also be a remote manner), a keyboard-video-mouse (KVM) switch can be used to couple the input devices and/or output devices to the processors and/or memory storage devices. In some embodiments, the KVM switch also can be part of customer front end system 320, customer device 330, internal frontend system 340, and/or employee device 350. In a similar manner, the processors and/or memory storage devices can be local and/or remote to each other.

In certain embodiments, customer device 330 and/or employee device 350 each can be a mobile device, and/or other endpoint devices used by one or more users (e.g., customer 331, employee 351). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, smart watches, an augmented-reality (AR) headset, a virtual-reality (VR) headset, etc.), or another portable computer device with the capability to present audio and/or visual data (e.g., images, videos, music, etc.).

Thus, in many examples, a mobile device can include a volume and/or weight sufficiently small as to permit the mobile device to be easily conveyable by hand. For example, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, and/or (ii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, and/or (ii) the Android™ operating system developed by the Open Handset Alliance.

Meanwhile, in many embodiments, backend system 310 and/or frontend systems 320 and/or 340 can be configured to communicate with one or more databases. The one or more databases can include a rewards database (e.g., 414, described below) that contains information about the rewards issued to and/or redeemed by customers, such as insurance policyholders. The information within the rewards database can include customer identifiers, reward types, reward values, issuance dates, redemption statuses, expiration dates, and/or other suitable data. In some embodiments, the one or more databases can store information related to the regulatory frameworks applicable to the rewards, such as federal, state, city, and/or local regulations that govern the issuance and redemption of rewards. This regulatory information can include the maximum and/or minimum allowable reward values, number of rewards during a certain time period (e.g., week, month, year, lifetime), categorization rules, and any temporal restrictions on reward issuance. In various embodiments, the rewards information can be transferrable to a different insurance company or attached to the customer to ensure regulatory compliance in the event of switching companies. In some embodiments, the one or more databases can include customer profile databases that contain demographic, geographic, and behavioral information of the customers. This information can encompass ages, genders, driving records, policy details, premium amounts, and customer loyalty metrics. Additionally, the databases can store transactional data related to the rewards, such as redemption history, points balances, and any adjustments made to the rewards. In some embodiments, the one or more databases can include machine learning (ML) and/or artificial intelligence (AI) models that are used by the reward system (e.g., 312 described below) to predict customer behavior, optimize reward offerings, and personalize the rewards experience for each customer. These ML/AI models can be trained using historical data on customer interactions with the rewards program, including redemption rates, customer feedback, and engagement levels. In some embodiments, the one or more databases can contain audit logs that track system interactions and changes to the rewards data, compliance with regulatory requirements, and/or handling and resolution of any discrepancies or disputes. These logs can include timestamps, customer actions, system responses, and any errors or exceptions encountered during the operation of the reward system. In some embodiments, the databases can include datasets for training and refining the ML/AI models, which can be sourced from third-party providers, generated through simulations, or compiled from historical customer interaction data. These datasets can be used to improve the accuracy and effectiveness of the models in predicting customer preferences and enhancing the overall efficiency of the reward system.

The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units. The one or more databases can include structured and/or indexed collections of data and can be managed by any suitable database management systems configured to define, create, query, organize, update, and manage databases. Exemplary database management systems can include MySQL (Structured Query Language) Database, PostgreSQL Database, Microsoft SQL Server Database, Oracle Database, SAP (Systems, Applications, & Products) Database, and IBM DB2 Database.

Communications within system 300, such as between backend system 310, frontend systems 320 and/or 340, and/or the one or more databases, can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In some embodiments, backend system 310 can include an API gateway 311, a reward system 312, an engagement system 313, a billing system 314, a message broker system 315, and/or other suitable components. The components of backend system 310 can be implemented as modules of computing instructions (e.g., software modules) stored on non-transitory computer-readable media that operate on one or more processors. Alternatively, or in addition, the components of backend system 310 can be implemented in hardware. The components of backend system 310 described herein are merely exemplary, and other suitable arrangements of components within system 300 are contemplated.

Frontend systems 320 and/or 340 can interface with various components of backend system 310 through API gateway 311. In some embodiments, API gateway 311 can serve as an intermediary that processes and routes requests from clients to various services within backend system 310, such as reward system 312, engagement system 313, and billing system 314. In some embodiments, API gateway 311 can act as a single point of entry for all client interactions with the backend services, handling tasks such as request routing, composition, and protocol translation. In some embodiments, API gateway 311 can implement security measures, including authentication and authorization, to ensure controlled and secure access to the backend services. In some embodiments, API gateway 311 can provide additional functionalities like load balancing, caching, request shaping, and management of API quotas and rate limits. Furthermore, API gateway 311 can offer monitoring and analytics capabilities, enabling the tracking of API usage patterns and the performance of the backend services.

In some embodiments, engagement system 313 can interact with customers to promote active participation and involvement in various activities and programs, such as those offered by an auto insurance provider or other company. In some embodiments, engagement system 313 can facilitate the creation, management, and tracking of activities that qualify customers for rewards, can send notifications and reminders to customers about ongoing challenges, new opportunities for earning rewards, and updates on their rewards status, and/or can provide a platform for customers to engage in activities that may include safe driving courses, feedback surveys, or promotional events. In some embodiments, engagement system 313 can be integrated with social media and other digital marketing tools to enhance customer interaction and engagement. In some embodiments, engagement system 313 can use data analytics to tailor engagement strategies to individual customer preferences and behaviors, thereby increasing the effectiveness of the engagement efforts. In some embodiments, engagement system 313 can allow customers to track their progress in activities and see an overview of the rewards they have earned or are eligible to earn. Furthermore, engagement system 313 can be configured to collect customer feedback and data, which can be used to improve the rewards program and ensure that it remains appealing and relevant to the customer base.

In some embodiments, reward system 312 can provide and manage a rewards ledger, which can act as the source of truth for rewards. Reward system 312 can publish data to message broker system 315. In some embodiments, reward system 312 can function as the central component within backend system 310 that manages the issuance, tracking, and redemption of rewards for customers. In some embodiments, reward system 312 can maintain a comprehensive ledger of rewards, categorizing them according to various criteria such as reward type, value, and regulatory compliance. In some embodiments, reward system 312 can implement algorithms and processes to ensure that the issuance of rewards adheres to the respective limits set by different regulatory frameworks, including state, city, local, and federal regulations. In some embodiments, reward system 312 can provide interfaces for other systems, such as engagement system 313 and billing system 314, to interact with reward data, facilitating a seamless integration of rewards into broader customer engagement and billing processes. In some embodiments, reward system 312 can offer capabilities for real-time updates and notifications, enabling immediate reflection of reward transactions in the customer's account. In some embodiments, reward system 312 can include features for fraud detection and prevention, to provide for the integrity of the rewards program. In some embodiments, reward system 312 can be equipped with reporting and analytics tools, allowing for the monitoring of reward program effectiveness and customer engagement levels. In some embodiments, reward system 312 can track the total annual dollar amount of rewards that can be awarded to each customer (e.g., 331). Reward system 312 can automatically limit the total annual dollar amount of rewards that can be awarded to a customer 331 so as not to exceed limits set out by various regulations, such as state, city, local, and federal regulations that could trigger tax events or other regulatory considerations, or company policies.

In some embodiments, billing system 314 can be configured to generate customer invoices and can react to rewards that are issued and/or redeemed. For example, when customer 331 redeems a reward, billing system 314 can adjust the customer's invoice accordingly. Billing system 314 can subscribe to updates from message broker system 315, to provide accurate billing based on rewards and engagement activities. In some embodiments, billing system 314 can manage financial transactions related to the rewards program within backend system 310. In some embodiments, billing system 314 can generate invoices and statements that reflect the impact of rewards on the financial obligations of customers. In some embodiments, billing system 314 can implement processes to automatically adjust billing amounts based on the redemption of rewards to provide that the financial benefits of rewards are accurately applied to customers' accounts. In some embodiments, billing system 314 can include features for handling payment processing, including the acceptance of various payment methods and the secure storage of payment information. In some embodiments, billing system 314 can be equipped with fraud detection mechanisms to safeguard against unauthorized transactions. Additionally, billing system 314 can provide reporting and analytics tools to monitor financial aspects of the rewards program, such as redemption rates, cost analysis, and revenue impact.

In some embodiments, message broker system 315 can provide the ability to publish and consume events. In some embodiments, message broker system 315 can act as a communication hub within backend system 310, facilitating the exchange of messages and data between different components, such as reward system 312, engagement system 313, and billing system 314. For example, when a customer 331 earns a reward, an event may be published to the message broker system 315. Reward system 312 can then consume this event and update the rewards ledger accordingly. Message broker system 315 can enable the publication and subscription of events, ensuring that updates related to rewards issuance, redemption, and adjustments are disseminated in real-time to the relevant systems. In some embodiments, message broker system 315 can provide queuing and topic-based messaging capabilities to manage the flow of information and maintain system efficiency.

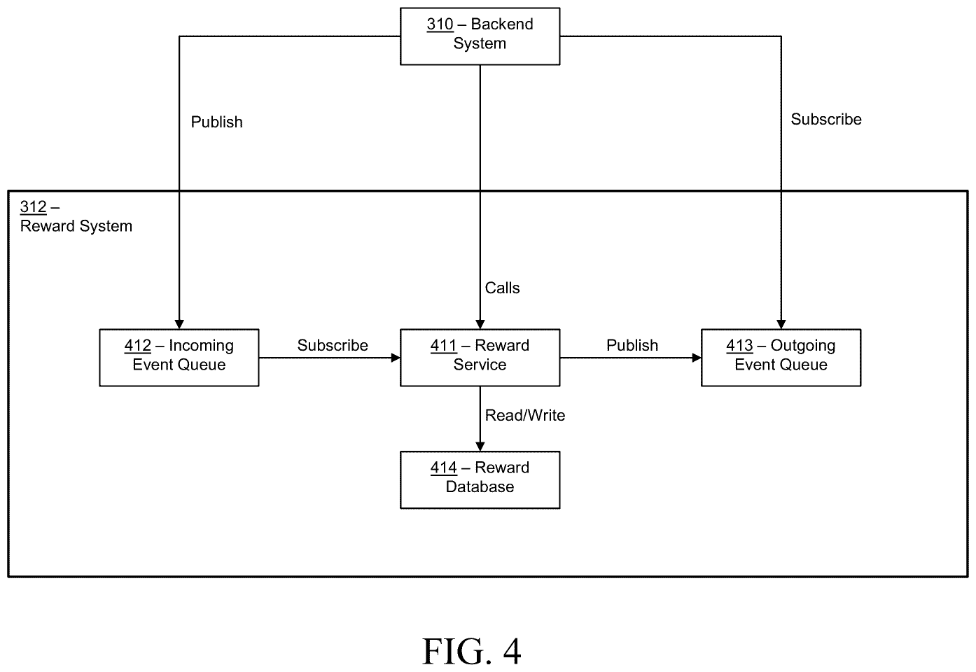

Turning to ahead in the drawings, FIG. 4 illustrates a block diagram of exemplary components of reward system 312. Reward system 312 is exemplary and not limited to the embodiments presented herein. The reward system can be employed in many different embodiments or examples not specifically depicted or described herein. In some embodiments, various components of reward system 312 can perform a range of procedures, processes, operations, actions, and/or activities. In other embodiments, these procedures, processes, operations, actions, and/or activities can be performed by other suitable components of reward system 312 and/or system 300.

Referring to FIG. 4, reward system 312 can include a reward service 411, an incoming event queue 412, an outgoing event queue 413, a rewards database 414, and/or other suitable components. These components of reward system 312 can communicate with other components of backend system 310, such as depicted in FIG. 4.

In some embodiments, incoming event queue 412 can provide a conduit for capturing events related to the issuance of rewards within reward system 312. Incoming event queue 412 can provide a queue to receive events and/or notifications, such as each time a customer (e.g., 331 (FIG. 3)), earns a reward. These notifications can be based on activities such as challenges, customer care interactions, marketing initiatives, or customer research participation. In some embodiments, incoming event queue 412 can categorize and prioritize events based on the source and type of reward, to process them in accordance with the regulatory frameworks that govern their issuance.

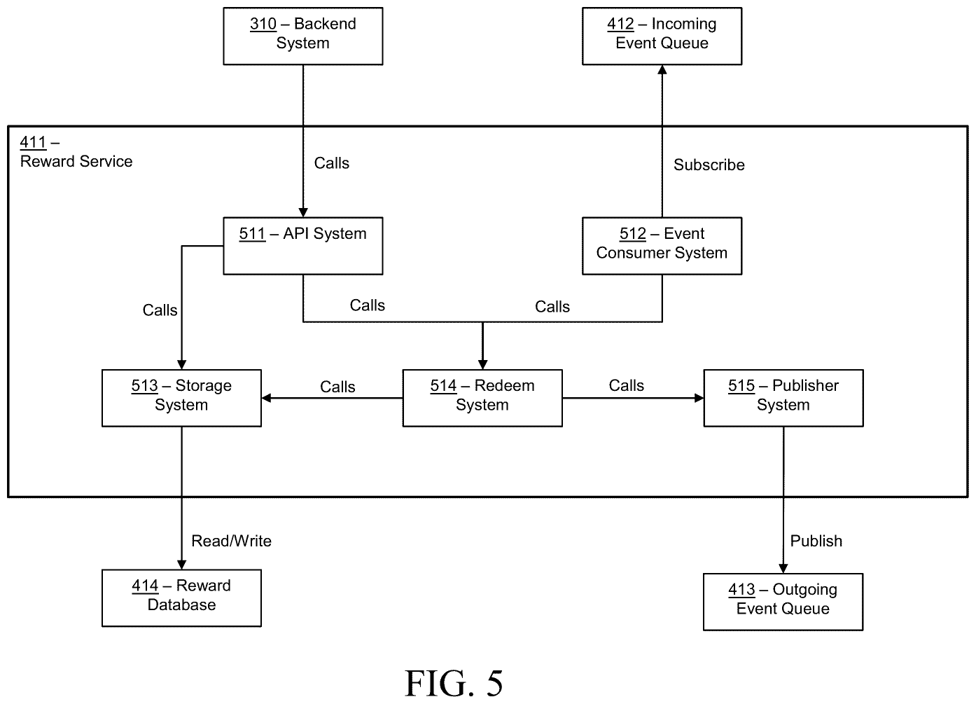

In some embodiments, reward service 411 can provide direct access to reward information, such as by providing a gRPC API or another suitable interface. gRPC is an open-source, high-performance Remote Procedure Call (RPC) framework that can run in any environment and can enable client and server applications to communicate transparently. In many embodiments, reward service 411 can categorize and tracking various types of rewards, including digital rewards such as badges and rewards of monetary value. In some embodiments, reward service 411 can interact with a central ledger in reward database 414, writing to and reading from it each time a customer earns a reward. This ledger serves as a single source for tracking all regulatory limits, enabling auto insurers to confidently offer and issue rewards. Further details regarding various embodiments of reward service 411 are shown in FIG. 5 and described below.

In some embodiments, outgoing event queue 413 can serve as a mechanism for disseminating information related to the management of rewards within reward system 312. Outgoing event queue 413 can provide a queue for outgoing events and/or notifications, such as when a reward transaction occurs. For example, an event can occur when a customer (e.g., 331 (FIG. 3)) redeems a reward or when a reward is adjusted in response to regulatory compliance checks.

In some embodiments, reward database 414 can provide the source of record for reward information. Reward database 414 can provide a central ledger for storing and tracking detailed information about each reward that a customer (e.g., 313 (FIG. 3)) earns. The information about the rewards can include the type and value of the rewards, such as digital badges or monetary rewards, as well as their categorization based on the source, such as challenges, customer care, marketing initiatives, or customer research activities. In some embodiments, reward database 414 can be structured to support compliance with state, city, local, and federal regulations by categorizing rewards according to their nature, distinguishing between those that are considered mitigating risk and thus potentially exempt from some regulatory limits, and those that are promotional or for research, which are generally subject to these limits.

As shown in FIG. 4, in some embodiments, other components of backend system 310 can make calls directly to reward service 411, such as through gRPC calls, and/or can communicate through queues 412-413, such as by publishing to incoming event queue 412, and subscribing to outgoing event queue 413.

Turning to ahead in the drawings, FIG. 5 illustrates a block diagram of exemplary components of reward service 411. Reward service 411 is exemplary and not limited to the embodiments presented herein. The reward service can be employed in many different embodiments or examples not specifically depicted or described herein. In some embodiments, various components of reward service 411 can perform a range of procedures, processes, operations, actions, and/or activities. In other embodiments, these procedures, processes, operations, actions, and/or activities can be performed by other suitable components of reward service 411 and/or system 300.

Referring to FIG. 5, rewards service 411 can include an API system 511, an event consumer system 512, a storage system 513, a redeem system 514, and a publisher system 515, and/or among other suitable components. These components of rewards service 411 can interact with each other and/or with additional components of backend system 310, facilitating the management of rewards as depicted in FIG. 4. In some embodiments, API system 511 can serve as an interface for external and internal requests and/or provide an API entry point. In some embodiments, the API can be a gRPC API, as described above, or another suitable type of interface, for handling calls from other components of backend system 310. In some embodiments, event consumer system 512 can process incoming events related to reward activities by subscribing to incoming events queue 412 in order to consume events from upstream systems that generate rewards. In some embodiments, redeem system 514 can manage the validation and redemption of rewards, by verifying reward limits to ensure compliance with regulatory limits. In some embodiments, storage system 513 can provide a data access layer to save and retrieve information, such as by reading from and/or writing to reward database 414 to maintain and update reward records. In some embodiments, publisher system 515 can publish messages for reward events, to handle the dissemination of reward-related events to outgoing event queue 413.

### Exemplary Data Model for Reward System

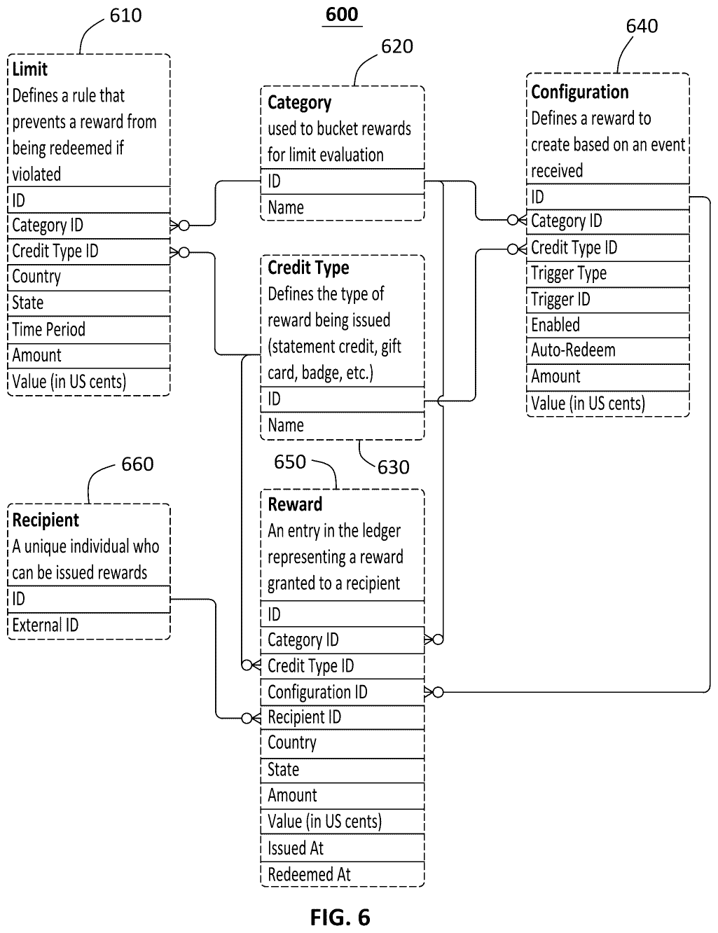

Turning ahead in the drawings, FIG. 6 illustrates an entity relationship diagram of an exemplary data model 600 that can be used for the data stored in reward database 414 (FIGS. 4-5). The entity relationship diagram of FIG. 6 shows exemplary entities, attributes, and relationships for data model 600. Data model 600 is exemplary and not limited to the embodiments presented herein. The data model can be employed in many different embodiments or examples not specifically depicted or described herein.

Referring to FIG. 6, data model 600 can include a limit entity 610, a category entity 620, a credit type entity 630, a configuration entity 640, a reward entity 650, and a recipient entity 660, among other suitable components. These components of the data mode 600 can interact with each other to facilitate the management and issuance of rewards within the system.

Referring to FIG. 6, data model 600 can include a limit entity 610, a category entity 620, a credit type entity 630, a configuration entity 640, a reward entity 650, a recipient entity 660, and/or other suitable entities. These entities of data model 600 and the attributes thereof can be structured to support the management and tracking of rewards within the system.

In some embodiments, limit entity 610 can define a rule that prevents a reward from being redeemed if the rule is violated, which can establish constraints that govern the redemption of rewards to ensure adherence to various regulatory frameworks. Attributes of limit entity 610 can include an identifier (ID), a category ID (which can be associated with the ID attribute of category entity 620 described below), a credit type ID (which can be associated with the ID attribute of credit type entity 630 described below), a country, a state, a time period, and amount, a value, and/or other suitable attributes. An example of a limit is that for U.S. federal regulations, there is a $600 per calendar year limit on all rewards, regardless of type. Another example of a limit is that, in the State of Arizona, there is a $100 limit per calendar year for rewards that are not categorized as risk mitigation. Various different states have different regulations. For example, Rhode Island can have a limit of $250 per calendar year. Yet another example of a limit is that a company can have a company policy to not give more than a certain amount per year, such as $150 per calendar year. Such a company policy can be predetermined or determined algorithmically. As another example, a partnership agreement with GasBuddy can limit GasBuddy subsidies to $25 per month and $250 per year, and in Nevada, there can be a state limit of $0 per year. In some embodiments, a monetary value of physical rewards can be tracked. For example, a T-shirt may have a $15 value.

Yet another example of a limit could be a regulation that imposes a minimum amount that a company is to issue within a calendar year. For example, a local regulation could impose a requirement that an auto insurer is to issue one or more rewards totaling at least $10 per year. The system described herein can track if the minimum requirement is met.

In some embodiments, category entity 620 can be used to classify rewards into distinct groups for the purpose of evaluating limits. Attributes of category entity 620 can include an ID and a name for the category. For example, the various different categories can include risk mitigation, promotional, research & survey, statutory credit, manual credit, and/or other suitable categories. In many embodiments, these categories can be based on specific regulatory limits. For example, in Arizona, rewards that are classified as risk mitigation do not count toward the $100 per calendar year limit. An example of a reward that can be considered risk mitigation is if an auto insurer gives something of value, such as a car phone holder having a $15 value, and that thing of value mitigates risk, such as a car phone holder limiting the risk of distracted driving. In some embodiments, the limit can apply to a category and/or a credit type, can apply within a specific state or more generally, and/or can be for a monetary limit of rewards for a specific time period.

In some embodiments, credit type entity 630 can specify the nature of the reward being issued, such as statement credit, gift card, physical reward, digital reward (e.g., badge), a GasBuddy subsidy, and/or other suitable credit types. Although some rewards may have no monetary value, such as some digital rewards, such as badges, titles, etc., these rewards can be tracked as well. Attributes of credit type entity 630 can include an ID and a name for the credit type.

In some embodiments, configuration entity 640 can define a reward to be created based on a triggering event received. Attributes of configuration entity 640 can include an ID, a category ID (which can be associated with the ID attribute of category entity 620), a credit type ID (which can be associated with the ID attribute of credit type entity 630), a trigger type, a trigger ID, an enabled flag, an auto-redeem flag, an amount, and a value.

In some embodiments, reward entity 650 can be an entry in the ledger for a reward granted to a recipient. Attributes of reward entity 650 can include an ID, a category ID (which can be associated with the ID attribute of category entity 620), a credit type ID (which can be associated with the ID attribute of credit type entity 630), a configuration ID (which can be associated with the ID attribute of configuration entity 640), a recipient ID (which can be associated with an ID attribute of recipient entity 660 described below), a country, a state, an amount, a value, an issued at attribute, and a redeemed at attribute. Issuance can refer to when the reward is presented to the customer, and redemption can refer to when the customer has accepted the reward and is credited with having received the reward.

In some embodiments, recipient entity 660 can uniquely identify an individual who is authorized to receive rewards. Attributes of recipient entity 660 can include an ID and an external ID. The external ID can link the recipient to how the customer is identified in other systems, such as in other systems used by the company operating backend system 310.

### Exemplary Methods for Managing Rewards

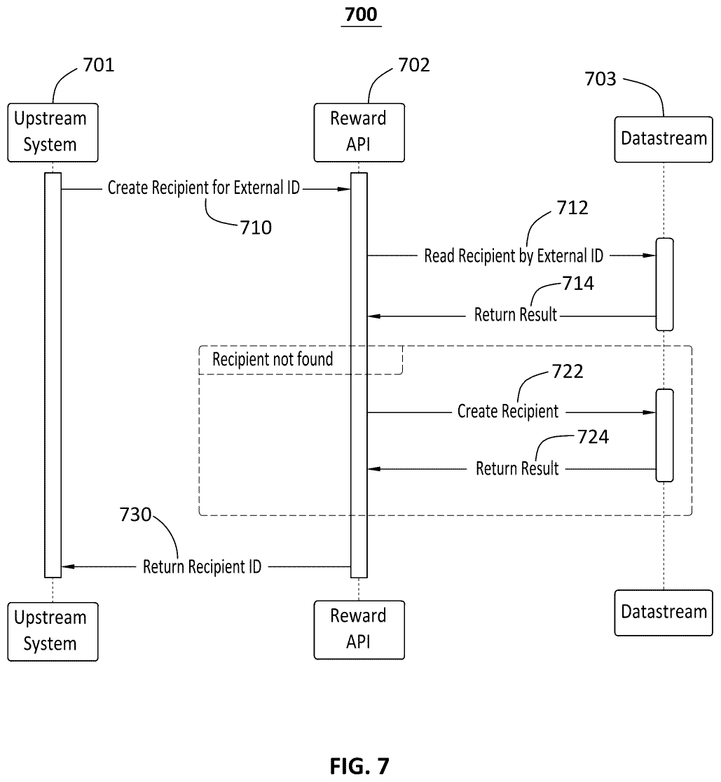

Turning ahead in the drawings, FIG. 7 illustrates a sequence diagram for a method 700 for retrieving a reward recipient, according to certain embodiments. Method 700 can be implemented via execution of computing instructions configured to run on one or more processors and stored on one or more non-transitory computer-readable media. Method 700 is exemplary and is not limited to the embodiments presented herein. The method can be employed in many different embodiments or examples not specifically depicted or described herein. In some embodiments, the procedures, the processes, the operations, the actions, and/or the activities of method 700 can be performed in the order presented. In other embodiments, the procedures, the processes, the operations, the actions, and/or the activities of method 700 can be performed in any suitable order. In still other embodiments, one or more of the procedures, the processes, the operations, the actions, and/or the activities of method 700 can be combined or skipped.

In many embodiments, system 300 or backend system 310 (FIG. 3) (including one or more of its elements, modules, and/or systems, etc.) can be suitable to perform method 700 and/or one or more of the operations, actions, and/or activities of method 700. In these or other embodiments, one or more of the operations, actions, and/or activities of method 700 can be implemented as one or more computing instructions configured to run on one or more processors and configured to be stored on one or more non-transitory computer readable media. Such non-transitory computer readable media can be part of a computer system such as system 300 or backend system 310 (FIG. 3). The processor(s) can be similar or identical to the processor(s) described above with respect to computer system 100 (FIG. 1).

Referring to FIG. 7, in many embodiments, method 700 can involve various activities and/or interactions, such as messages, calls, or responses, between various systems, such as one or more upstream systems 701, a reward API 702, and/or a database 703. Upstream systems 701 can be similar or identical to customer application 321 (FIG. 3), support application 341 (FIG. 3), and/or one or more of backend systems 310 (FIG. 3), such as engagement system 313 (FIG. 3), billing system 314 (FIG. 3), etc. Reward API 702 can be similar or identical to API gateway 311 (FIG. 3), reward service 411 (FIG. 4), API system 511 (FIG. 5), etc. Database 703 can be similar or identical to reward database 414 (FIG. 4).

In some embodiments, method 700 can include upstream system 701 making a call 710 to reward API 702 to create a recipient for an external ID. Next, method 700 can include reward API 702 making a call 712 to database 703 to read the recipient by the external ID, and the result can be returned from database 703 to reward API 702 in a response 714. If the recipient is not found in the database 703, as indicated by response 714, then reward API 702 can make a call 722 to database 703 to create the recipient, and the result can be returned from database 703 to reward API 702 in a response 724. For example, upon successful creation, database 703 can confirm the creation of the recipient in response 724. Nex, reward API 702 can return the recipient ID to upstream system 701 with a response 730, completing the process of recipient creation within the reward system.

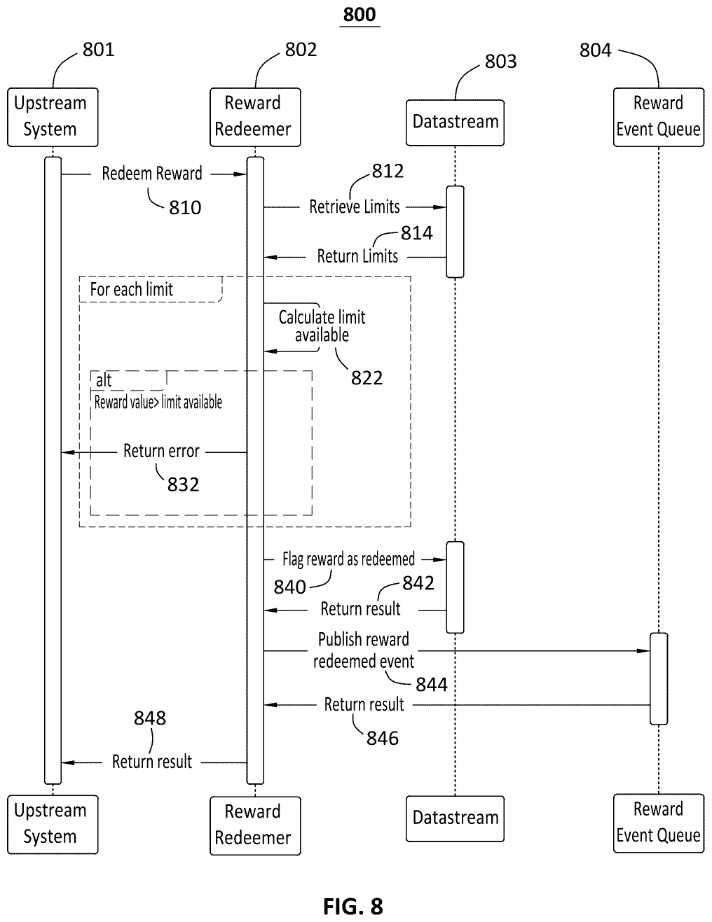

Turning ahead in the drawings, FIG. 8 illustrates a sequence diagram for a method 800 of redeeming a reward, according to various embodiments. Method 800 can be implemented via execution of computing instructions configured to run on one or more processors and stored on one or more non-transitory computer-readable media. Method 800 is exemplary and is not limited to the embodiments presented herein. The method can be employed in many different embodiments or examples not specifically depicted or described herein. In some embodiments, the procedures, the processes, the operations, the actions, and/or the activities of method 800 can be performed in the order presented. In other embodiments, the procedures, the processes, the operations, the actions, and/or the activities of method 800 can be performed in any suitable order. In still other embodiments, one or more of the procedures, the processes, the operations, the actions, and/or the activities of method 800 can be combined or skipped.

In many embodiments, system 300 or backend system 310 (FIG. 3) (including one or more of its elements, modules, and/or systems, etc.) can be suitable to perform method 800 and/or one or more of the operations, actions, and/or activities of method 800. In these or other embodiments, one or more of the operations, actions, and/or activities of method 800 can be implemented as one or more computing instructions configured to run on one or more processors and configured to be stored on one or more non-transitory computer-readable media. Such non-transitory computer-readable media can be part of a computer system such as system 300 or backend system 310 (FIG. 3). The processor(s) can be similar or identical to the processor(s) described above with respect to computer system 100 (FIG. 1).

Referring to FIG. 8, in many embodiments, method 800 can involve various activities and/or interactions, such as messages, calls, or responses, between various systems, such as one or more upstream systems 801, a reward redeemer 802, a database 803, and/or a reward event queue 804. Upstream systems 801 can be similar or identical to customer application 321 (FIG. 3), support application 341 (FIG. 3), one or more of backend systems 310 (FIG. 3), such as engagement system 313 (FIG. 3), billing system 314 (FIG. 3), and/or upstream system 701 (FIG. 7), etc. Reward redeemer 802 can be similar or identical to redeem system 514 (FIG. 5). Database 803 can be similar or identical to reward database 414 (FIG. 4) and/or database 703 (FIG. 7). Reward event queue 804 can be similar or identical to outgoing event queue 413 (FIG. 4).

In some embodiments, method 800 can include upstream system 801 initiating a call 810 to reward redeemer 802 to redeem a reward. Next, method 800 can include reward redeemer 802 making a call 812 to database 803 to retrieve limits to determine the applicable limits for the reward, and the limits can be returned from database 803 to reward redeemer 802 in a response 814. Next, for each limit returned in response 814, reward redeemer 802 can perform an activity 822 of calculating the amount available within the limit. When the reward value is greater than the amount available, reward redeemer 802 can return an error to upstream system 801 in a response 832. Otherwise, in the case in which the reward value is within the amount available, reward redeemer 802 can confirm the redemption of the reward by making a call 840 to database 803 to flag the reward as redeemed, and database 803 can return the result of call 840 in a response 842. Reward redeemer 802 also can make a call 844 to reward event queue 804 to publish a reward redeemed event, and reward event queue 804 can return the result of call 844 in a response 846. Next, reward redeemer 802 can return the result to upstream system 801 in a response 848, thereby completing the reward redemption within the reward system.

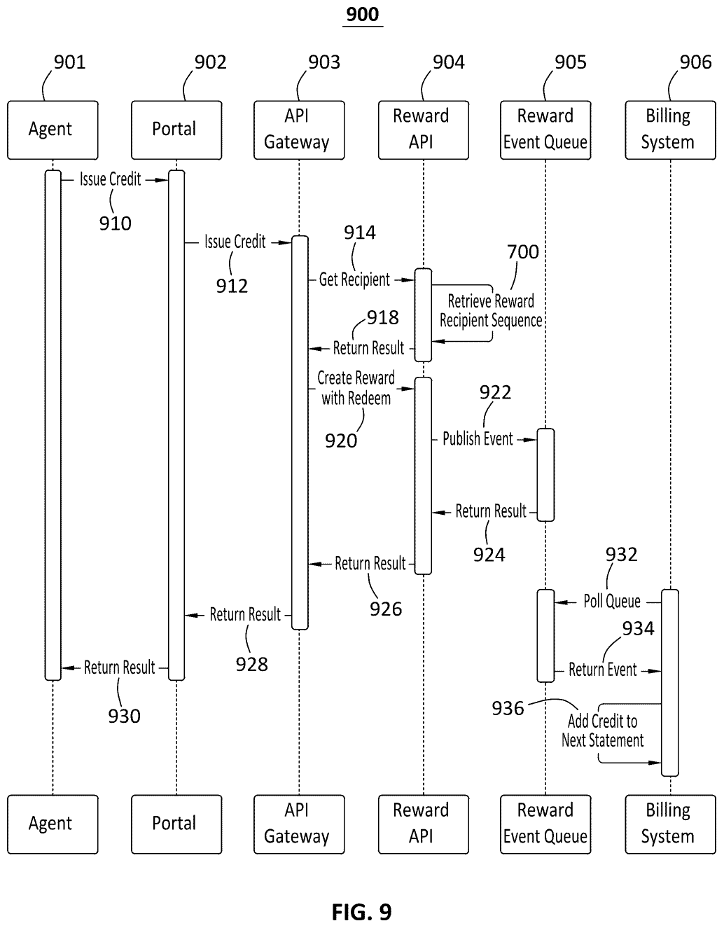

Turning ahead in the drawings, FIG. 9 illustrates a sequence diagram for a method 900 of processing a customer care statement credit, according to various embodiments. Method 900 can be implemented via execution of computing instructions configured to run on one or more processors and stored on one or more non-transitory computer-readable media. Method 900 is exemplary and is not limited to the embodiments presented herein. The method can be employed in many different embodiments or examples not specifically depicted or described herein. In some embodiments, the procedures, the processes, the operations, the actions, and/or the activities of method 900 can be performed in the order presented. In other embodiments, the procedures, the processes, the operations, the actions, and/or the activities of method 900 can be performed in any suitable order. In still other embodiments, one or more of the procedures, the processes, the operations, the actions, and/or the activities of method 900 can be combined or skipped.

In many embodiments, system 300 or backend system 310 (FIG. 3) (including one or more of its elements, modules, and/or systems, etc.) can be suitable to perform method 900 and/or one or more of the operations, actions, and/or activities of method 900. In these or other embodiments, one or more of the operations, actions, and/or activities of method 900 can be implemented as one or more computing instructions configured to run on one or more processors and configured to be stored on one or more non-transitory computer-readable media. Such non-transitory computer-readable media can be part of a computer system such as system 300 or backend system 310 (FIG. 3). The processor(s) can be similar or identical to the processor(s) described above with respect to computer system 100 (FIG. 1).

Referring to FIG. 9, in many embodiments, method 700 can involve various activities and/or interactions, such as messages, calls, or responses, between various systems, such as an agent 901, a portal 902, an API gateway 903, a reward API 904, a reward event queue 905, and/or a billing system 906. Agent 901 can be similar or identical to employee 351 (FIG. 3) and/or employee device 350 (FIG. 3). Portal 902 can be similar or identical to support application 341 (FIG. 3) and/or internal frontend system 340 (FIG. 3). API gateway 903 can be similar or identical to API gateway 311 (FIG. 3). Reward API 904 can be similar or identical to API system 511 (FIG. 5) and/or reward API 702 (FIG. 7). Reward event queue 905 can be similar or identical to outgoing event queue 413 (FIG. 4) and/or reward event queue 804 (FIG. 8). Billing system 906 can be similar or identical to billing system 314 (FIG. 3).

In some embodiments, method 900 can include agent 901 making a call 910 to portal 902 to issue a credit, such as a statement credit. For example, a statement credit can be offered by the employee to a customer as compensation for service dissatisfaction, to rectify a billing error, as part of a promotional offer, as part of loyalty rewards, as part of a sign-up bonus or milestone award, or based on an insurance claim.

Next, method 900 can include portal 902 making a call 912 to API gateway 903 to issue the credit. API gateway 903 then can send a request 914 to reward API 904 to retrieve the recipient for the reward. Reward API 904 can retrieve the reward recipient by initiating method 700, as described above in association with FIG. 7, after which reward API 904 can return the result to API gateway 903 in a response 918. Upon successful retrieval, API gateway 903 can make a call 920 to reward API 904 to create a reward with redemption. Next, reward API 904 can make a call 922 to publish an event to a reward event queue 905. Next, results can be returned from reward even queue 905 to reward API 904 in a response 924, from reward API 904 to API gateway 903 in a response 926, from API gateway 903 to portal 902 in a response 928, and from portal 902 to agent 901 in a response 930.

Meanwhile, billing system 906 can perform an activity 932 of polling reward event queue 905, and once the event has been published to reward event queue 905, the polling can retrieve the event in a response 934, to communicate the event to billing system 906. Next, billing system 906 can perform an activity 936 or processing the event and applying the credit to the next statement, which can result in the statement credit reward redemption being reflected in the customer's billing account.

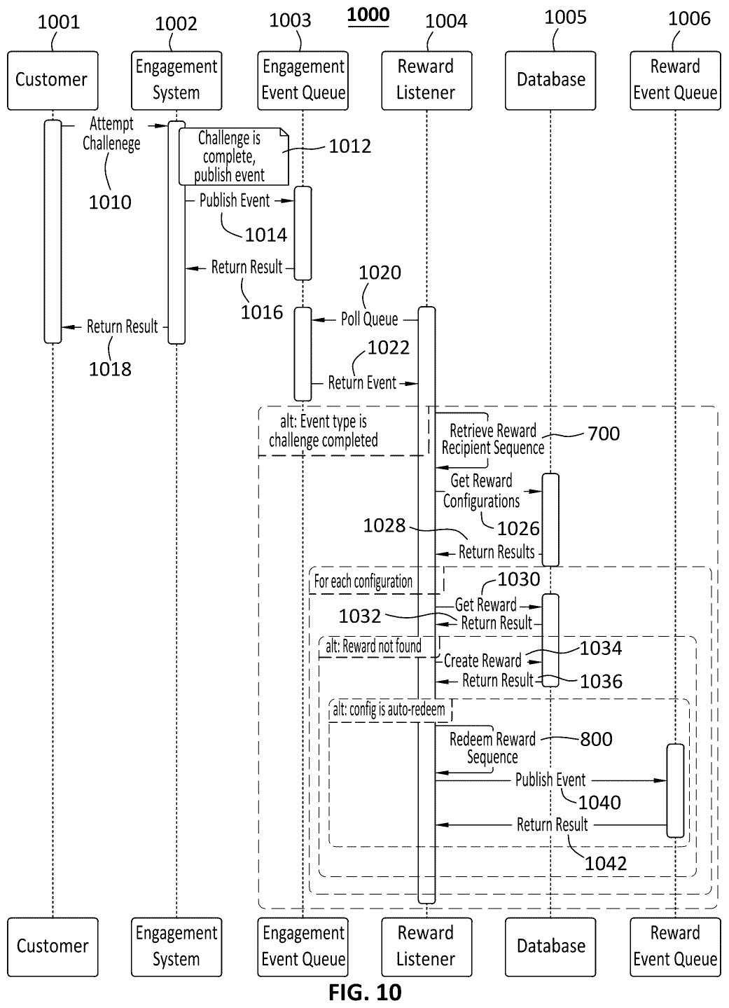

Turning ahead in the drawings, FIG. 10 illustrates a sequence diagram for a method 1000 of processing a reward based on customer engagement, according to various embodiments. Method 1000 can be implemented via execution of computing instructions configured to run on one or more processors and stored on one or more non-transitory computer-readable media. Method 1000 is exemplary and is not limited to the embodiments presented herein. The method can be employed in many different embodiments or examples not specifically depicted or described herein. In some embodiments, the procedures, the processes, the operations, the actions, and/or the activities of method 1000 can be performed in the order presented. In other embodiments, the procedures, the processes, the operations, the actions, and/or the activities of method 1000 can be performed in any suitable order. In still other embodiments, one or more of the procedures, the processes, the operations, the actions, and/or the activities of method 1000 can be combined or skipped.

In many embodiments, system 300 or backend system 310 (FIG. 3) (including one or more of its elements, modules, and/or systems, etc.) can be suitable to perform method 1000 and/or one or more of the operations, actions, and/or activities of method 1000. In these or other embodiments, one or more of the operations, actions, and/or activities of method 1000 can be implemented as one or more computing instructions configured to run on one or more processors and configured to be stored on one or more non-transitory computer-readable media. Such non-transitory computer-readable media can be part of a computer system such as system 300 or backend system 310 (FIG. 3). The processor(s) can be similar or identical to the processor(s) described above with respect to computer system 100 (FIG. 1).

Referring to FIG. 10, in many embodiments, method 1000 can involve various activities and/or interactions, such as messages, calls, or responses, between various systems, such as a customer 1001, an engagement system 1002, an engagement event queue 1003, a reward listener 1004, a database 1005, and/or a reward event queue 1006. Customer 1001 can be similar or identical to customer 331 (FIG. 3) and/or customer device 330 (FIG. 3). Engagement system 1002 can be similar or identical to engagement system 313 (FIG. 3), customer application 321 (FIG. 3), and/or customer frontend system 320 (FIG. 3). Engagement event queue 1003 can be similar or identical to incoming event queue 412 (FIG. 4) and/or message broker system 315 (FIG. 3). Reward listener 1004 can be similar or identical to event consumer system 512 (FIG. 5). Database 1005 can be similar or identical to reward database 414 (FIG. 4), database 703 (FIG. 7), and/or database 803 (FIG. 8). Reward event queue 1006 can be similar or identical to outgoing event queue 413 (FIG. 4), reward event queue 804 (FIG. 8), and/or reward event queue 905 (FIG. 9).

In some embodiments, method 1000 can include customer 1001 performing an activity 1010 of attempting a challenge through engagement system 1002. Examples of challenges that may be issued to auto insurance customers as part of a rewards program can include: (1) a safe driving knowledge challenge, in which customers are rewarded for learning about safe driving through quizzes or informational modules, such as through customer application 321 (FIG. 3); (2) a safe driving performance challenge, in which customers are rewarded for maintaining a safe driving record over a specified period, such as no speeding tickets or at-fault accidents; (3) a low mileage challenge, in which rewards are offered to customers who drive fewer than a set number of miles within a given timeframe, promoting less frequent vehicle use; (4) a driver education challenge, in which customers earn rewards for completing defensive driving courses or other driver education programs, such as through customer application 321 (FIG. 3); (5) a vehicle maintenance challenge, in which rewards are given for performing regular vehicle maintenance, such as oil changes, tire rotations, or scheduled service check-ups, as verified by service receipts or a maintenance app; (6) a telematics-based challenge, in which customers are challenged to exhibit good driving behaviors, such as smooth acceleration and braking, adherence to speed limits, and safe cornering; (7) a carpooling or eco-friendly driving challenge, in which customers are incentivized for participating in carpooling or for using eco-friendly driving practices that reduce emissions; (8) a season safety challenge, in which challenges are performed around seasonal driving conditions, such as winterizing a vehicle or driving safely in adverse weather conditions; (9) a community engagement challenge, in which rewards are offered for participating in community safety programs or charity events sponsored by the insurance company; (10) a customer loyalty challenge, in which long-term customers can receive rewards for their continued patronage, such as discounts or special offers on policy renewals; and/or other suitable challenges. Such challenges can be designed to encourage behaviors that reduce risk, promote safety, and engage customers with their auto insurance provider. For example, a challenge may be completed when a user completes five learning quizzes within a one-week period.

Upon successful completion of the challenge, engagement system 1002 can perform an activity 1012 of recording that the challenge is complete, after which engagement system 1002 can make a call 1014 to engagement event queue 1003 to publish the challenge completion event. Engagement event queue 1003 can then return a result to engagement system 1002 in a response 1016, after which engagement system 1002 can return a result to customer 1001 in a response 1018, confirming the challenge outcome.

Meanwhile, reward listener 1004 can perform an activity 1020 of polling engagement event queue 1003, and upon detecting the challenge completed event, can retrieve the event in a response 1022 to reward listener 1004. Based on the challenge being completed, reward listener 1004 can retrieve the reward recipient by initiating method 700, as described above in association with FIG. 7, after which reward listener 1004 can make a call 1026 to database 1005 to fetch the reward configurations, such as data stored in database 1005 in the format of configuration entity 640 (FIG. 6), which can be returned from database 1005 to reward listener 1004 in a response 1028. Next, for each configuration, reward listener 1004 can make a call 1030 to database 1005 to get the reward for the configuration, if the reward exists, which can be returned from database 1005 to reward listener 1004 in a response 1032. If no reward exists for the configuration, a reward can be created by reward listener 1004 making a call 1034 to database 1005 to create the reward, after which database 1005 can store a new reward and return the result in a response 1036 to reward listener 1004.

If the configuration for the reward is auto-redemption, such as automatically redeeming the reward without further confirmation from customer 1001, then reward listener 1004 can initiate redeeming the reward by initiating method 800, as described above in association with FIG. 8, after which reward listener 1004 can make a call 1040 to reward event queue 1006 to publish the reward redemption event, after which reward event queue 1006 can return a result to reward listener 1004 in a response 1042. This process results in the reward redemption being reflected in the reward account of customer 1001.

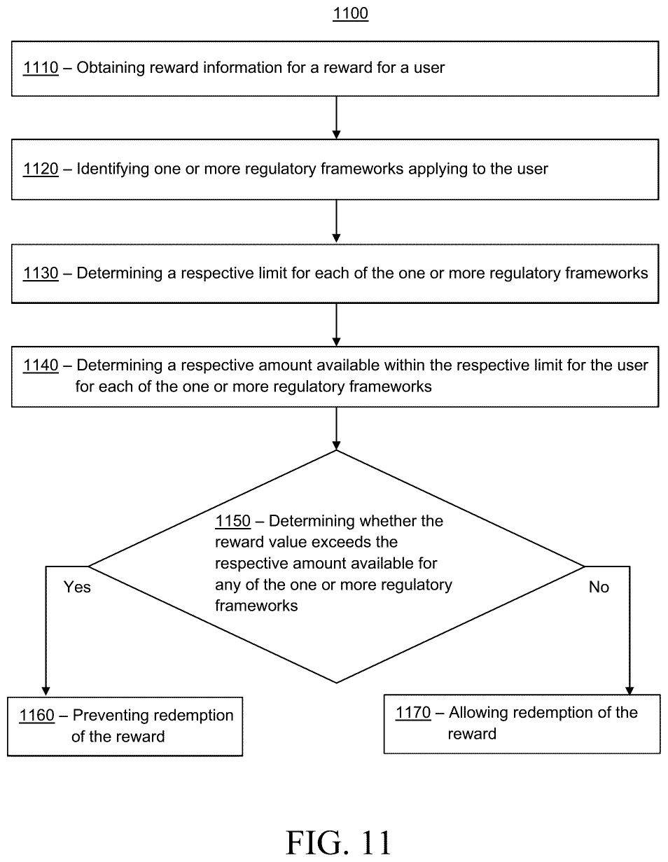

Turning ahead in the drawings, FIG. 11 illustrates a flowchart of a method 1100 for managing rewards in regulatory-compliant rewards tracking, according to various embodiments. Method 1100 is merely exemplary and is not limited to the embodiments presented herein. Method 1100 can be employed in many different embodiments or examples not specifically depicted or described herein. In some embodiments, the procedures, the processes, and/or the activities of method 1100 can be performed in the order presented. In other embodiments, the procedures, the processes, and/or the activities of method 1100 can be performed in any suitable order. In still other embodiments, one or more of the procedures, the processes, and/or the activities of method 1100 can be combined or skipped.

In many embodiments, system 300 (FIG. 3), backend system 310 (FIG. 3), and/or reward system 312 (FIG. 3) can be suitable to perform method 1100 and/or one or more of the activities of method 1100. In these or other embodiments, one or more of the activities of method 1100 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1).

Referring to FIG. 11, method 1100 can include an activity 1110 of obtaining reward information for a reward for a user. The reward information can include a reward category, a credit type, a reward value, and/or other suitable information, such as data associated with reward entity 650 (FIG. 6). In some cases, upon qualification for a reward by the user, the reward information can be obtained, and the reward can be issued to the user. In some embodiments, the user qualifies for the reward based on completing a challenge. The database can be similar or identical to reward database 414 (FIG. 4). In some embodiments, the reward information can be obtained by polling an event queue to determine when the user qualifies for the reward, then retrieving an event when it is added to the queue, to obtain the reward information.

In some embodiments, method 1100 also can include an activity 1120 of identifying one or more regulatory frameworks applying to the user. The regulatory frameworks can be various state, city, local, and federal regulations that govern the total annual dollar amount that can be awarded to a customer, such as within one or more categories. In some embodiments, the regulatory frameworks can include a business limit imposed by a business associated with issuing the reward to the user. In many embodiments, the regulatory frameworks that apply to the user can be based on a locale of the user, as various frameworks can be based on a residence of the user or a location in which the user transacts.

In some embodiments, method 1100 also can include an activity 1130 of determining a respective limit for each of the one or more regulatory frameworks. The limit can be similar or identical to data associated with limit entity 610 (FIG. 6). As an example, the respective limits can be determined based on the locale of the user and the category of the reward, such as whether the reward is promotional, risk-mitigation, research, statutory credit, or manual credit, which can be included in the limit data pulled from the database (e.g., reward database 414 (FIG. 4)). In some embodiments, the limit can be maximum and/or minimum allowable reward values, number of rewards during a certain time period (e.g., week, month, year, lifetime), categorization rules, and any temporal restrictions on reward issuance. In some embodiments, activity 1130 can be similar or identical to method 800 (FIG. 8) or portions thereof, such as messages 812 and 814 (FIG. 8).

In some embodiments, method 1100 additionally can include an activity 1140 of determining a respective amount available within the respective limit for the user for each of the one or more regulatory frameworks. In some embodiments, the rewards system 312 can access the ledger to track the rewards redeemed by the user and calculate the amount available within the respective limit for the user. The ledger can be a blockchain ledger or other suitable type of ledger. In some embodiments, activity 1140 can be similar or identical to method 800 (FIG. 8) or portions thereof, such as activity 822 (FIG. 8).

In some embodiments, method 1100 can include an activity 1150 of determining whether the reward value exceeds the respective amount available for any of the one or more regulatory frameworks. In many embodiments, activity 1150 can include determining whether the reward value exceeds the respective amount available within the reward category for the reward.

In some embodiments, if the reward value exceeds the respective amount available, method 1100 can proceed to an activity 1160 of preventing redemption of the reward. In other embodiments, if the reward value does not exceed the available amount, the process can proceed to an activity 1170 of allowing the redemption of the reward. These activities can provide that the rewards issued to the user remain within the regulatory limits and do not trigger tax events or other regulatory considerations. In some embodiments, when there is a limit that would prevent the redemption of full value of the reward, but a partial value of the reward would fit within the limit, there can be a partial redemption of the reward, where feasible. In some embodiments, the reward can be split into two rewards of smaller value, one of which is redeemed, and the other of which is prevented from being redeemed at that time, but potentially could be redeemed at a later time.

### Exemplary Machine Learning Models

In many embodiments, the systems and/or methods can use one or more ML/AI models to perform one or more of the above-mentioned procedures, processes, activities, actions, operations, and/or methods. Further, the systems and/or methods can use one or more natural language processing (NLP) models for processing the one or more inputs and/or outputs (e.g., interpreting user feedback). Examples of the algorithms used for the various ML/AI models can include BERT, LLM, Lambda, Palm, XLNet, GPT-3, GPT-4, KNN, decision trees, linear regression, K-Means, neural networks, fuzzy logic, GANs, CTGAN, CNNs, VAEs, and so forth. In various embodiments, each of the ML/AI models used can be trained dynamically and/or regularly.

In many embodiments, the systems and/or methods can be configured to train or re-train the one or more ML/AI models. The training of each of the ML/AI models can be supervised, semi-supervised, and/or unsupervised, which in some embodiments can be followed by, or used in conjunction with, other techniques, such as re-enforcement machine learning techniques, or other techniques utilized by ChatGPT-based voice bots or virtual assistants. The training data of training datasets for pre-training or re-training each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In many embodiments, the trained and/or re-trained ML/AI model as well as the training datasets can be stored in, updated, and accessed from a database (e.g., rewards database 414 (FIG. 4)).

In some embodiments, the systems, methods, and/or system users (e.g., a data scientist) further can determine whether to add the newly-created historical input and/or output data to the training dataset for retraining the ML/AI models based upon user feedback, predetermined criteria, and/or confidence scores for the historical output data. The user feedback can be associated with the output data of the ML/AI models or the output of the systems and/or methods using the ML/AI models.

In certain embodiments where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In several embodiments, the one or more ML/AI models can be configured to start or stop automatically upon occurrence of predefined events and/or conditions. In certain embodiments, the systems and/or methods can use a pre-trained ML/AI model, without any re-training.

### ADDITIONAL CONSIDERATIONS

Although managing rewards in regulatory-compliant rewards tracking has been described with reference to specific embodiments, it will be understood by those skilled in the art that various changes can be made without departing from the spirit or scope of the disclosure. For example, the embodiments described herein can be used to track any type of rewards systems such as rewards for doing well in school, or good behavior at home, completing a task, or excelling at work. Accordingly, the disclosure of embodiments is intended to be illustrative of the scope of the disclosure and is not intended to be limiting.

It is intended that the scope of the disclosure shall be limited only to the extent required by the appended claims. For example, to one of ordinary skill in the art, it will be readily apparent that any element of FIG. 1-11 can be modified, and that the foregoing discussion of certain of these embodiments does not necessarily represent a complete description of all possible embodiments. Additionally, one or more of the procedures, processes, operations, actions, and/or activities of the methods in FIGS. 4-11 can include different procedures, processes, actions, and/or activities and be performed by many different modules, in many different orders, or interchanged between such methods. As another example, the modules, models, elements, and/or systems within system 300 or backend system 310 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system can be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.1 second, 0.5 second, one second, two seconds, five seconds, ten seconds, or thirty seconds, for example.

This written description uses examples to disclose the disclosure, including the best mode, and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer-implemented method comprising:
using a reward listener to poll an event queue to determine when a user qualifies for a reward, wherein the event queue is populated through a reward API making a call to publish an event to the event queue;
obtaining, from the event queue, reward information for the reward for the user, the reward information comprising a reward category, a credit type, and a reward value;
identifying one or more regulatory frameworks applicable to the user;
determining a respective amount limit for each of the one or more regulatory frameworks;
determining whether the reward value exceeds the respective amount limit available for any of the one or more regulatory frameworks; and
when the reward value exceeds the respective amount limit available for any of the one or more regulatory frameworks, preventing redemption of the reward.

2. The computer-implemented method of claim 1, wherein determining whether the reward value exceeds the respective amount limit available for any of the one or more regulatory frameworks further comprises:
determining whether the reward value exceeds the respective amount limit available within the reward category for the reward.

3. The computer-implemented method of claim 1, wherein identifying the one or more regulatory frameworks further comprises:
identifying the one or more regulatory frameworks based on a locale of the user.

4. The computer-implemented method of claim 1, wherein the reward category is one of promotional, risk-mitigation, research, statutory credit, or manual credit.

5. The computer-implemented method of claim 1, wherein the one or more regulatory frameworks comprise a U.S. federal regulation.

6. The computer-implemented method of claim 5, wherein the one or more regulatory frameworks further comprise a U.S. state regulation.

7. The computer-implemented method of claim 1, wherein the one or more regulatory frameworks comprise a business limit imposed by a business associated with issuing the reward to the user.

8. The computer-implemented method of claim 1, wherein determining whether the reward value exceeds the respective amount limit available for any of the one or more regulatory frameworks further comprises:
accessing a ledger that tracks rewards redeemed by the user during one or more time periods.

9. The computer-implemented method of claim 8, wherein the ledger is a blockchain ledger.

10. The computer-implemented method of claim 1, wherein the reward information is obtained after the user qualifies for the reward and the reward is issued to the user.

11. The computer-implemented method of claim 1, wherein the user qualifies for the reward based on completing a challenge.

12. The computer-implemented method of claim 1, wherein the event queue is an outgoing event queue populated by a reward service that is subscribed to an incoming event queue.

13. A system comprising one or more processors and one or more non-transitory computer-readable media storing computing instructions that, when executed on the one or more processors, cause the one or more processors to perform operations comprising:
using a reward listener to poll an event queue to determine when a user qualifies for a reward, wherein the event queue is populated through a reward API making a call to publish an event to the event queue;
obtaining, from the event queue, reward information for the reward for the user, the reward information comprising a reward category, a credit type, and a reward value;
identifying one or more regulatory frameworks applicable to the user;
determining a respective amount limit for each of the one or more regulatory frameworks;
determining whether the reward value exceeds the respective amount limit available for any of the one or more regulatory frameworks; and
when the reward value exceeds the respective amount limit available for any of the one or more regulatory frameworks, preventing redemption of the reward.

14. The system of claim 13, wherein determining whether the reward value exceeds the respective amount limit available for any of the one or more regulatory frameworks further comprises:
determining whether the reward value exceeds the respective amount limit available within the reward category for the reward.

15. The system of claim 13, wherein identifying the one or more regulatory frameworks further comprises:
identifying the one or more regulatory frameworks based on a locale of the user.

16. The system of claim 13, wherein the reward category is one of promotional, risk-mitigation, research, statutory credit, or manual credit.

17. The system of claim 13, wherein determining whether the reward value exceeds the respective amount limit available for any of the one or more regulatory frameworks further comprises:
accessing a ledger that tracks rewards redeemed by the user during one or more time periods.

18. The system of claim 13, wherein:
the reward information is obtained after the user qualifies for the reward and the reward is issued to the user; and
the user qualifies for the reward based on completing a challenge.

19. The system of claim 13, wherein the event queue is an outgoing event queue populated by a reward service that is subscribed to an incoming event queue.

20. One or more non-transitory computer-readable media storing computing instructions that, when executed on one or more processors, cause the one or more processors to perform operations comprising:
using a reward listener to poll an event queue to determine when a user qualifies for a reward, wherein the event queue is populated through a reward API making a call to publish an event to the event queue;
obtaining, from the event queue, reward information for the reward for the user, the reward information comprising a reward category, a credit type, and a reward value;
identifying one or more regulatory frameworks applicable to the user;
determining a respective amount limit for each of the one or more regulatory frameworks;
determining whether the reward value exceeds the respective amount limit available for any of the one or more regulatory frameworks; and
when the reward value exceeds the respective amount limit available for any of the one or more regulatory frameworks, preventing redemption of the reward.
